(19) United States
(12) Patent Application Publication
(10) Pub. No.: US 2004/0237368 A1
(43) Pub. Date: Dec. 2, 2004

(54) Label for plants, system and method for printing information on plastic or resin made labels for plants

(76) Inventors: Kurt Baunsgaard Paskesen, Brande (DK); Frank Kragelund Hansen, Silkeborg (DK)

Correspondence Address: CANTOR COLBURN, LLP, 55 GRIFFIN ROAD SOUTH, BLOOMFIELD, CT, 06002

(21) Appl. No.: 10/485,423

(22) PCT Filed: Apr. 18, 2002
(86) PCT No.: PCT/DK02/00252

(30) Foreign Application Priority Data
Aug. 3, 2001 (EP) 012029609

(51) Int. Cl. G09F 23/00

(52) U.S. Cl. 40/645

(57) ABSTRACT

A label for plants is provided, including a plastic or resin material, at least one section with a surface suitable for printing, and at least one section with means for holding the label to the plant, the surface including a porous structure.

A system and a method for printing information on labels for plants, are also provided by the invention.

### BACKGROUND OF THE INVENTION

The present invention relates to a label for plants according to the preamble of claim 1, system and method for printing information on plastic or resin made labels for plants according to the preamble of claim 8 and 11, respectively.

The labels for plants available on the marked are usually manufactured in either rigid cardboard or plastic material.

The cardboard labels have the significant disadvantage of being less resistant to outdoor weather in general.

The printing on the label will quickly fade away due to the sunlight and the rain will dissolve the cardboard quite fast. For this reason cardboard labels are only used where the information on the label is not interesting after the planting out of the plant.

The plastic labels are usually made in a styrene material that has a smooth and impervious surface. The plastic labels have a rather rigid structure depending on the thickness of the material.

The printing on the label will fade away due to the sunlight or be removed by the continuous pounding against the plant or other objects. The removing of the printing is accelerated by the nature of the surface on which the printing is applied.

The creation of information on the label involves a number of steps that may include an initial step of printing text information on labels where the labels usually come in sheets including numerous labels. Hereafter a separately printed image may be glued on the labels to enhance the level of information to a purchaser of plants. Finally, a bar code and a price may as a separate printed part be glued on the labels.

The printing is usually performed with a printer such as a laser printer connected to a standard computer. However, the plastic labels have a significant disadvantage since the material handles high temperatures poorly. The material starts to melt due to the high temperature in connection with the fixation of the printing in the printer which frequently effects a breakdown of the printer. The temperature characteristics of the material also limit the amount of information that can be printed on a label. For example, is it often not possible to print images or barcodes.

The printing on the labels may also be performed with the use of offset, matrix or thermal printing. However, the printing costs will be high per label unless very large series of labels are printed.

An object of the invention is to create a label for plants that has improved and long lasting printing characteristics irrespective of weather conditions.

A further object is the creation of a system where smaller series of labels may be printed in a cost efficient manner.

### SUMMARY OF THE INVENTION

The invention relates to a label for plants where the label has a surface including a porous structure such as a microporous structure.

Hereby, it is possible to produce a label for plants which has improved and long lasting printing characteristics irrespective of weather conditions since the printing penetrates the surface and into the pores of the material where it is protected by against weather conditions. Further, because of the penetration into the surface, the printing is less endangered of being illegible due to cracks in the surface or in the printed matter.

Even further, no coating or aftertreatment of the label is necessary to protect the printed matter.

It should be emphasised that with the term “label for plants” is meant a material affixed to a plant or placed in proximity of a plant to indicate different information about the plant.

It should be emphasised that with the term “plant” is meant any member of the vegetable group of living organisms including flowers and trees. The use of the invention is especially in connection with plants in or from nurseries and similar places.

The invention is especially advantageous in connection with plants having a longer growth period before being harvested, removed or before they die. An example is trees such as Christmas trees where the growth period may be several years and where it is very important to keep track of the history of the plant, such as age, specie and supplier of the plant.

The label material is preferably a biologically inert material e.g. a material that will not affect the plant growth or health.

In an aspect of the invention, said surface comprises a thermoplastic polymer with a softening temperature between 50 and 200 degrees Celsius and preferably above 65 degrees Celsius. Hereby, advantageous features have been achieved in relation to the temperature in general and especially during printing since the temperature of a printer may be up to 300 degrees Celsius on the printer drum. The polymer material will achieve a lower temperature than 200 degrees Celsius because of the movement of the material where the temperature is defined by the speed of the material in the printer.

In another aspect, said label comprises a polyolefin material having a surface with a porous structure such as a microporous structure, whereby it is possible to create labels for plants with advantageous characteristics. A characteristic of a polyolefin material is its less rigid nature which makes it easier and safer for the workers to place the present labels on the plants. Especially, since the edges on the labels are not sharp as the known ones, thus will also minimize damage to the plants in connection with the placing of labels.

The less rigid nature of the present labels for plants also has the advantage of being soundless where the known labels make noise when they are moved by the wind. In an area where many plants e.g. thousands of plants are placed together the noise level may be quite high on a windy day, which among other things lowers the quality of the working environment.

A label for plants in a polyolefin material is very temperature resistant to both high and low temperatures which ensures that the printing will not be damaged due to changes in temperature. This is especially advantageous since the labels for plants will endure significant temperature fluctuations from the high temperatures during the printing process to low temperatures during winter conditions after the placing on the plant.

Further, the polyolefin material is inert to electrostatic charging which usually will occur during the printing process and will often be problem with normal plastic materials. The electrostatic charging will inflict on the quality of the layers of colour and especially the homogeneity of the layer thickness, e.g. cause spots with only little printing material. Often the thickness is directly connected to the durability of the printing especially in outdoor applications or extreme situations e.g. damp or moist, cold or warm environments and therefor it is essential to have a certain minimum thickness of the layer of print.

In a third aspect of the invention, fibres of said material are substantially directed in one direction and preferably in a longitudinal direction. Hereby it is possible to create sheets of labels which are easy to separate after the printing due to the less strength of the material in a longitudinal direction. Further, the strength ensures that the label is not easily damaged after the fixation to a peduncle of a plant since forces applied to the label e.g. by nature especially will be in the longitudinal direction.

In a fourth aspect of the invention, the average diameter of the pores in said microporous structure range between 0.01 to 1 micrometers and preferably between 0.01 and 0.5 micrometers. Hereby, it is possible to achieve a preferred relation between penetration into the pores of the surface and protection by against weather conditions.

In a fifth aspect of the invention, said surface includes a text area, an image area and an identification code and/or price area. Hereby, it is possible to print the necessary information on the label in one process without the use of separate elements such as images glued to label in a subsequent process.

In a sixth aspect of the invention, at least one side comprising a porous surface is coated on a further material with a more rigid structure than said surface. Hereby it is possible to create labels with the above-mentioned advantages and a rigid structure.

The invention further relates to a system in which said labels comprise a least one surface with a porous structure and printing on said surface is performed as part of a single process. Hereby it is possible to create a system which involves fewer components and work processes than normally.

Hereby, it is possible to create a system where smaller series of labels may be printed in a cost efficient manner.

In an aspect of the invention, said label comprises a polyolefin material and said printer is a laser printer and preferably a colour or an LED printer. Hereby it is possible to perform the printing process without any material melting problems causing the printer to breakdown. Further, the ability of the polyolefin material to absorb the printing and heat allows a faster printing process and thus a better printing result than with prior used materials.

The label may totally be made in polyolefin material which allows printing on both sides of the label. Further, water or moist cannot penetrate the solid material and peeling is thus not possible.

The invention further relates to a method where said different printing steps are performed as part of a single process. Hereby it is possible to enhance the quality of the printing as well as accelerate the process of printing.

In an even further aspect of the invention, said text, images and identification codes and/or prices are loaded from a database with the use of a data connection such as an Internet connection. Hereby it is possible to store and retrieve information from a central database containing significant amounts of data which allows an accelerated process both in retrieving and printing of information on labels.

### THE FIGURES

The invention will be described in the following with reference to the figures, in which

FIG. 1 illustrates a normal place of use for the invention,

FIGS. 2a-d illustrate different embodiments of the invention,

FIG. 3 illustrates a sheet of labels,

FIG. 4 illustrates a label in a use position,

FIG. 5 illustrates a system for making of labels,

FIG. 6 illustrates a stake label as a second embodiment of the invention, and

FIGS. 7a and 7b illustrate the use a stake label in connection with a plant.

### DETAILED DESCRIPTION OF THE INVENTION

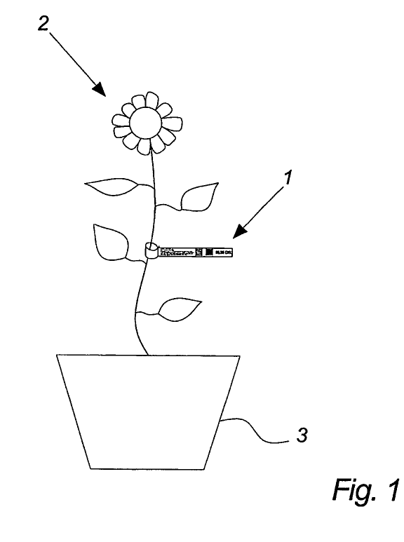

FIG. 1 illustrates a normal place of use for a label 1 according to the invention. The label 1 is fixed around a peduncle of a plant 2 in a loose but long-lasting manner. One side of the label 1 discloses different information regarding the plant it is fixed to.

The label 1 is partially or totally constructed in a plastic or resin material having a microporous surface. An example of a suitable material in connection with the invention is Teslin (Registered Trademark of PPG Industries, Inc). The characteristics of Teslin is further described in European Patent no. 0 289 859.

The microporous surface may have pores with an average diameter range between 0.01 to 1 micrometer and preferably between 0.01 and 0.5 micrometer.

Preferably, the material with the microporous surface has a thickness between 200 and 300 micrometer to ensure high printing quality.

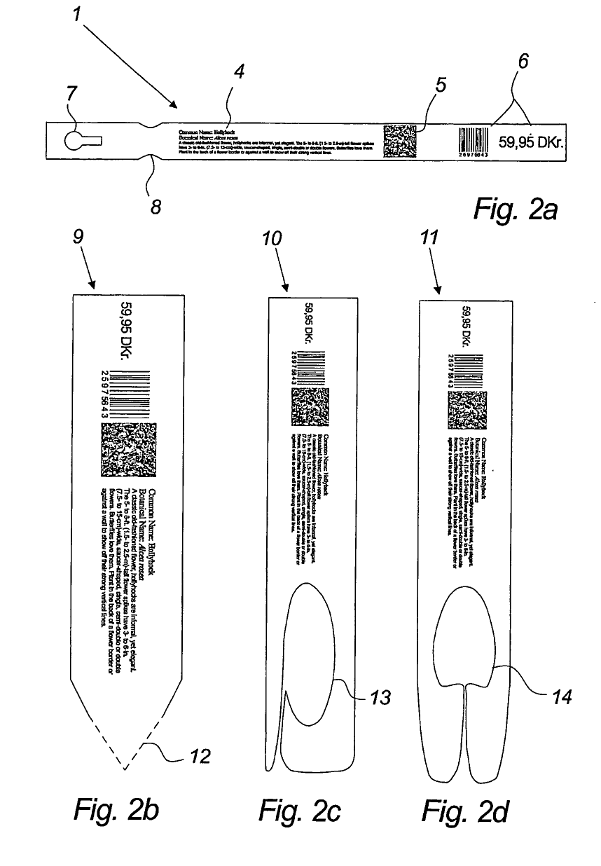

FIG. 2a illustrates a first embodiment of a label 1 for plants 2 according to the invention. The label 1 comprises a section with a number of areas for information printing such as a text area 4, an image area 5 and an identification and price area 6 where the identification may be a bar code.

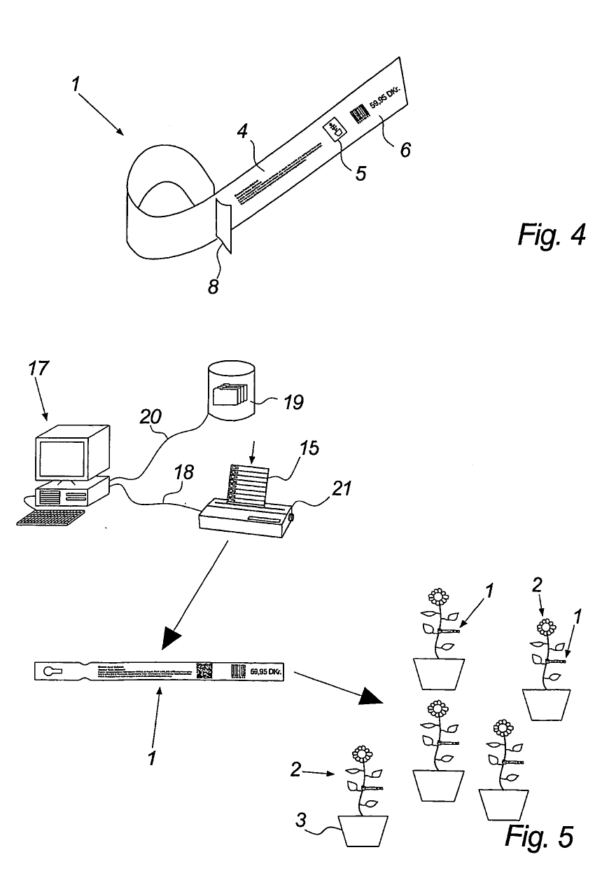

The label 1 further has an opening 7 and a narrowing section 8 placed next to each other in one end. The opposite end of the label may be lead through the opening 7 until the narrowing section 8 is reached where the narrowing section acts as a securing of the label 1 in a position of use (illustrated further in FIG. 4).

FIG. 2b illustrates a second embodiment of a label 1 for plants 2 in the shape of a stake 9 which is intended to be placed in the soil next to the plant 2 in question.

FIGS. 2c and 2d illustrate a third and fourth embodiment of a label for plants. The embodiments are in forms of a push-on 10 and a hang-on label 11 which both have a hold section 13, 14 with an opening and a split. The split allows the label to be placed on a plant 2 such as a branch.

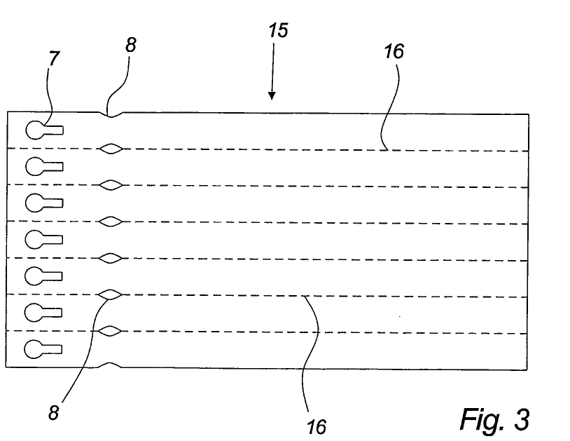

FIG. 3 illustrates a sheet 15 including a number of labels 1 where the sheet is divided by a number of longitudinal tear lines 16. After the necessary information has been printed on the sheet 15, the labels 1 are separated by tearing along the lines 16.

FIG. 4 illustrates the label of FIG. 1 in a use position where the label forms a circle to surround a branch or the like of a plant.

FIG. 5 illustrates a system for making plastic or resin made labels 1 for plants 2 where the system includes a computer 17 with a connection 20 to a printer 21 and a connection 18 to at least one database 19. The printer 21 may be a colour printer such as a laser or ink jet printer. The database 19 may be positioned on the harddrive of the computer or in another place where the connection between the computer and the database may be the Internet.

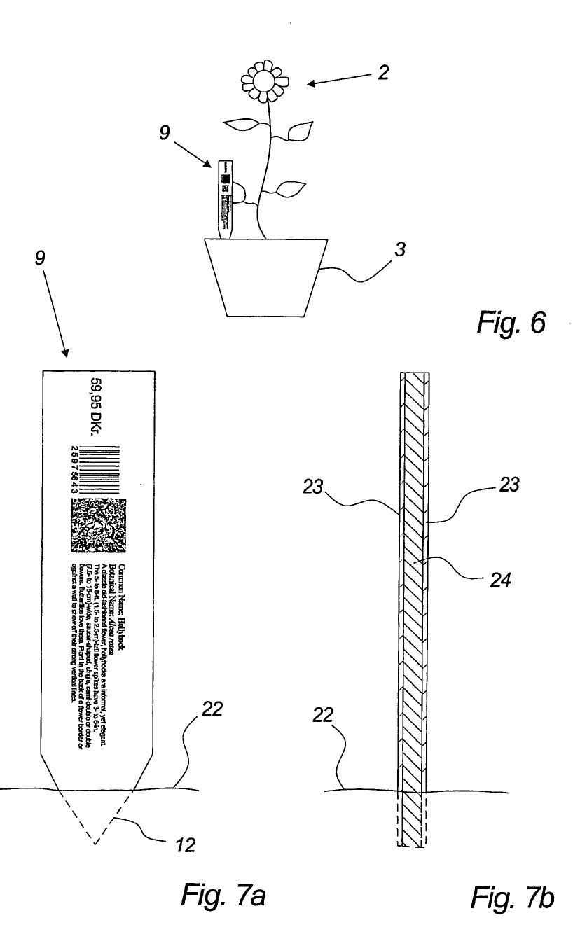

FIG. 6 illustrates the use of a stake label 9 in the soil of a potted plant where the stake label is partly stuck into the soil next to the plant 2.

FIGS. 7a and 7b illustrate the structure and use of a stake label according to a preferred embodiment of the invention.

FIG. 7a illustrates how a sharp end 12 of the stake label 9 is stuck into the soil. The rest of the stake includes areas for information printing such as a text area 4, an image area 5 and an identification and price area 6.

FIG. 7b illustrates an embodiment of a stake label 9 seen in a side view. The stake has microporous surfaces 23 surrounding a central material 24 with a more rigid structure than the surface material 23.

Preferably, each of the microporous surfaces 23 has a thickness between 100 and 150 micrometer and the central material 24 has a thickness between 200 and 300 micrometer to ensure high printing quality and a rigid structure.

However, the stake may also have just one microporous surface 23 placed on one side of the central material 24 e.g. if it is not necessary to print on both sides. In this situation the microporous surface 23 should have a thickness between 200 and 300 micrometer.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. Label for plants, comprising:
a plastic or resin material;
at least one section with a surface suitable for printing; and
at least one section with means for holding the label to said plant;
wherein
said surface includes a porous structure.

2. Label for plants according to claim 1, wherein said surface comprises a thermoplastic polymer with a softening temperature between 50 and 200 degrees and preferably above 65 degrees.

3. Label for plants according to claim 1, wherein said surface comprises a polyolefin material.

4. Label for plants according to claim 1, wherein fibres of said material substantially are directed in one direction.

5. Label for plants according to claim 1, wherein the porous structure comprises a microporous structure and the average diameter of pores in said microporous structure range between 0.01 to 1 micrometers.

6. Label for plants according to claim 1, wherein said surface includes a text area, an image area and an identification code and/or price area.

7. Label for plants according to claim 1, further comprising at least one side comprising a porous surface coated on a further material with a more rigid structure than said surface.

8. System for printing on plastic or resin made labels for plants, said system comprising:
a computer and a printer connected to said computer;
a sheet of labels with at least one surface suitable for printing;
wherein said labels comprise a least one surface of a porous structure and printing on said surface is performed as part of a single process.

9. System for printing on plastic or resin made labels for plants according to claim 8, wherein said label comprises a polyolefin material and said printer is a laser printer.

10. System for printing labels for plants according to claim 8, wherein said computer further comprises a connection to a database comprising pre-stored information including text regarding plants, images of plants and identification codes and/or prices.

11. Method for printing information on plastic or resin made labels for plants, said method comprising:
printing text on said text area;
printing one or more images on said image area; and
printing an identification code and/or price on said identification code and/or price area;
wherein
said different printing steps are performed as part of a single process.

12. Method for printing information on labels for plants according to claim 11, wherein said text, images and identification codes and/or prices are loaded from a database with the use of a data connection.

13. Label for plants according to claim 4, wherein the one direction comprises a longitudinal direction.

14. Label for plants according to claim 1, wherein the porous structure comprises a microporous structure and the average diameter of pores in said microporous structure range between 0.01 to 0.5 micrometers.

15. System for printing on plastic or resin made labels for plants according to claim 9, wherein said printer is a color or an LED printer.

16. System for printing labels for plants according to claim 10, wherein said connection comprises an internet connection.

17. Method for printing information on labels for plants according to claim 12, wherein said data connection comprises an internet connection.
